(19) United States
(12) Patent Application Publication
(10) Pub. No.: US 2026/0086566 A1
(43) Pub. Date: Mar. 26, 2026

(54) ATTITUDE CONTROL DEVICE

(71) Applicant: FUTABA CORPORATION, Mobara-shi (JP)

(72) Inventor: Masahiro TANAKA, Mobara-shi (JP)

(21) Appl. No.: 19/330,050

(22) Filed: Sep. 16, 2025

(30) Foreign Application Priority Data
Sep. 25, 2024 (JP) 2024-166530

(51) Int. Cl. G05D 1/495; B64U 10/25; B64U 40/10

(52) U.S. Cl. CPC G05D 1/495; B64U 10/25; B64U 40/10; B64U 2201/20

(57) ABSTRACT

An attitude control device mounted on a radio-controlled model airplane, which is a controlled object controlled based on a control signal received from an external device, comprises a calculation part configured to selectively output a first aileron control signal, which is input as the control signal, and a second aileron control signal, which is calculated based on a roll angle of the controlled object to maintain the controlled object in a horizontal state. The calculation part selects and outputs the second aileron control signal when the following conditions are satisfied: turning on of a function is instructed by a function setting signal received from the external device; the first aileron control signal is a signal indicating neutral; and the roll angle of the controlled object is within a set angle.

### CROSS-REFERENCE TO RELATED APPLICATIONS

This application claims priority to Japanese Patent Application No. 2024-166530 filed on Sep. 25, 2024, the entire contents of which are incorporated herein by reference.

### TECHNICAL FIELD

The present disclosure relates to an attitude control device mounted on an controlled object that is controlled based on a control signal received from outside.

### BACKGROUND

Some control systems for remotely controlling controlled objects such as model airplanes and drones have an attitude control function, as disclosed in the following Patent Documents 1 and 2, for example.

Patent Document 1 discloses a multicopter controlling method that reduces the complexity of controlling the multicopter and allows the thrill of controlling the multicopter.

Patent Document 2 discloses a flying object having a function of maintaining itself in a horizontal state.
(Patent Document 1) Japanese Laid-open Patent Publication No. 2018-2132
(Patent Document 2) Japanese Laid-open Patent Publication No. 2020-67880

### SUMMARY

As attitude control devices for flying objects, there are some devices having flight assist functions for beginners to intermediate users, such as devices that automatically perform leveling control using a function of automatically returning to level flight to maintain a horizontal attitude. Accordingly, the roll angle and pitch angle of the aircraft are detected from a gyro sensor (angular velocity sensor) and an acceleration sensor, thereby automatically controlling the aileron and the elevator to maintain a horizontal attitude. During the control for automatic returning to level flight, the control inputs of the aileron and the elevator are limited to a predetermined angle to prevent an excessive operation.

Here, in a normal turn, an operator (user) operates the aileron stick on the transmitter side to tilt the aircraft, then returns the aileron stick to neutral, and then pulls the elevator stick to turn the aircraft. After the turn is completed, the aileron stick is struck in the opposite direction to return the aircraft to the horizontal position to complete the turn operation. However, if a turn is attempted during the above-described control for automatically returning to level flight, the aileron input is limited and the aircraft cannot turn at a desired angle, resulting in a large turning circle.

In addition, at the time of landing, the elevator needs to be inputted to raise the nose of the aircraft. However, the elevator is automatically operated to return to the horizontal attitude, so that the nose of the aircraft is lowered, which may make stable landing difficult.

In addition, during the control for automatically returning to level flight, the pitch angle is limited and the elevator operation is not effective, which makes it difficult to perform a fine elevator stick operation for altitude and speed control.

Therefore, the present disclosure provides an attitude control device having a flight assist function different from the above-described function of automatically returning to level flight and capable of responding appropriately to operator's operations during turning or landing.

An attitude control device in accordance with the present disclosure is an attitude control device mounted on a radio-controlled model airplane, which is a controlled object controlled based on a control signal received from an external device, comprises a calculation part configured to selectively output a first aileron control signal, which is input as the control signal, and a second aileron control signal, which is calculated based on a roll angle of the controlled object to maintain the controlled object in a horizontal state, wherein the calculation part selects and outputs the second aileron control signal when the following conditions are satisfied: turning on of a function is instructed by a function setting signal received from the external device; the first aileron control signal is a signal indicating neutral; and the roll angle of the controlled object is within a set angle.

In other words, turning on of a function is instructed as a new flight assist function. Further, the new flight assist function is activated when the following conditions are satisfied: the first aileron control signal is neutral; and the roll angle is within a set angle. This function uses the aileron control signal calculated based on the roll angle to maintain the controlled object in a horizontal state. Maintaining the horizontal state indicates that the roll angle is maintained at approximately 0° or approximately 180°.

In the attitude control device of the present disclosure, a condition that the pitch angle of the controlled object is within a set angle may be added to the condition for activating the new function.

In accordance with the present disclosure, in the case of controlling an controlled object, it is possible to appropriately control turning, landing, or the like even when the flight assist function is activated.

### BRIEF DESCRIPTION OF THE DRAWINGS

FIG. 1 is a diagram showing a configuration example of a control system according to an embodiment of the present disclosure.

FIG. 2 is a block diagram of an internal configuration example of a transmitter and an controlled object according to an embodiment.

FIG. 3 is a block diagram of a configuration example of an attitude control device according to a first embodiment.

FIG. 4 is an explanatory diagram of a pulse width of a function setting signal according to an embodiment.

FIG. 5 is an explanatory diagram of a pulse width of an aileron control signal according to an embodiment.

FIG. 6 is a flowchart of a selection process of an aileron control signal according to a first embodiment.

FIG. 7 is a block diagram of a configuration example of an attitude control device according to a second embodiment.

FIG. 8 is a flowchart of a selection process of an aileron control signal according to a second embodiment.

FIG. 9 is a block diagram of a configuration example of an attitude control device according to a third embodiment.

### DETAILED DESCRIPTION

Hereinafter, embodiments of the present disclosure will be described in the following order.
<1. First embodiment>
[1-1 Example of System Configuration]
[1-2 Example of configuration of transmitter and controlled object]
[1-3 Configuration and processing of attitude control device]
<2. Second embodiment>
<3. Third embodiment>
<4. Effects of embodiments>

### 1. First Embodiment

### [1-1 System Configuration Example]

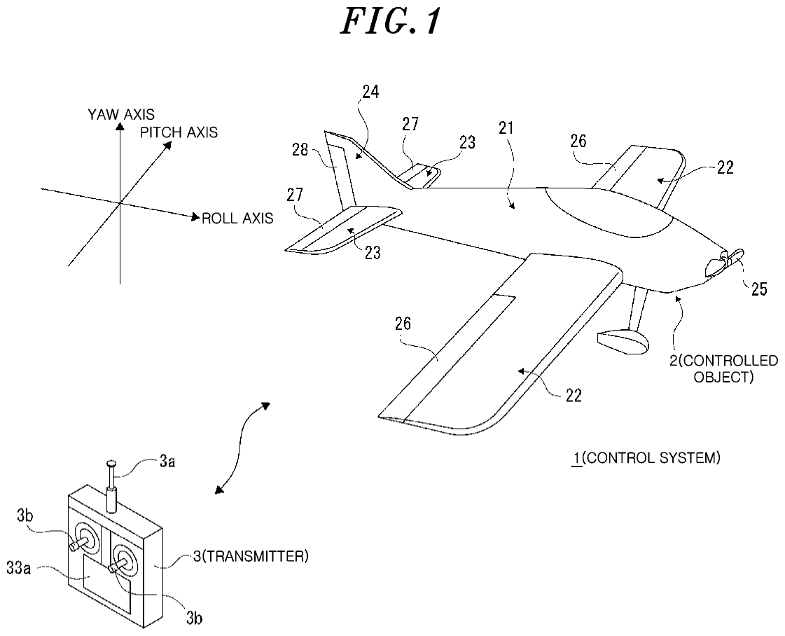

FIG. 1 shows a configuration example of a flight control system 1 according to an embodiment of the present disclosure.

In the following embodiment, a new flight assist function will be referred to as “roll flat function.” The roll flat function is also a function that automatically maintains the aircraft in a horizontal state. However, it is different from the above-described “function of automatically returning to level flight”, and thus is distinguished from the function of automatically returning to level flight.

The flight control system 1 includes at least a controlled object 2 and a transmitter 3.

The controlled object 2 is an object that is controlled based on a control signal received from outside. The transmitter 3 is a device that transmits various signals, including a control signal, to the controlled object 2.

In the present embodiment, a model airplane is an example of the controlled object 2.

The controlled object 2, which is a model airplane, includes a fuselage 21, a pair of main wings 22 and 22 on the left and right sides, horizontal tail wings 23 and 23, and a tail wing 24.

Here, the attitude of the controlled object 2 can be expressed by the direction of rotation around the roll axis, the direction of rotation around the pitch axis, and the direction of rotation around the yaw axis. In the drawing, the directions of the roll axis, pitch axis, and yaw axis are illustrated. As illustrated in the drawing, the roll axis is an axis penetrating through the fuselage 21 of the controlled object 2 from front to back, the pitch axis is an axis penetrating through the controlled object 2 from left to right, and the yaw axis is an axis penetrating through the controlled object 2 from top to bottom.

In the controlled object 2, each main wing 22 is provided with an aileron 26. Each horizontal tail wing 23 is provided with an elevator 27, and the vertical tail wing 24 is provided with a rudder 28.

The aileron 26 is a movable wing for rotating the controlled object 2 around the roll axis. The elevator 27 is a movable wing for rotating the controlled object 2 around the pitch axis, and the rudder 28 is a movable wing for rotating the controlled object 2 around the yaw axis.

The flight attitude of the controlled object 2 can be changed by operating the aileron 26, the elevator 27, and the rudder 28.

The controlled object 2 is provided with a propeller 25. The forward and backward thrust of the controlled object 2 can be obtained by the rotation of the propeller 25.

The controlled object 2 is configured such that the rotation direction of the propeller 25 can be switched. By switching the rotation direction of the propeller 25, the forward and backward movement of the controlled object 2 can be switched.

The transmitter 3 has a function of receiving a control operation from a user as an operator, and transmitting a control signal in response to the received operation.

The transmitter 3 has an antenna 3a for wirelessly transmitting a control signal, a manipulation element 3b for receiving a manipulation input for control, and a display screen 33a for displaying various information to a user as an operator.

Here, a transmitter 3 having two stick-shaped manipulation elements as the manipulation element 3b for control is shown as an example. However, the manipulation element 3b may not necessarily have a stick shape, and may have other shapes such as a wheel shape and the like. Further, the number of manipulation elements 3b may be other than two.

In this specification, “control signal” refers to a signal that instructs the operation of movable parts of the controlled object 2, such as the propeller 25, the aileron 26, the elevator 27, and the rudder 28.

In the control system 1, signals other than control signals that instruct the operation of the movable parts can also be transmitted from the transmitter 3 to the controlled object 2. For example, a function setting signal that instructs ON/OFF of the roll flat function is transmitted from the transmitter 3 to the controlled object 2.

In the control system 1, multiple channels can be used as signal transmission channels from the transmitter 3 to the controlled object 2. For example, in the control system 1, a total of 18 channels are available as signal transmission channels.

By using the multiple channels, the control signals for each movable part, such as the propeller 25, the aileron 26, the elevator 27, and the rudder 28, can be transmitted separately for each channel. Specifically, it is possible to set a signal to be transmitted for each channel. For example, the control signal for the propeller 25 can be assigned to a channel CH1, the control signal for the aileron 26 can be assigned to a channel CH2, and the control signal for the elevator 27 can be assigned to a channel CH3, for example.

In the setting of the assignment of transmission signals for each channel, it is also possible to assign signals other than control signals as transmission signals. For example, a function setting signal can be assigned to a channel CH5.

### [1-2 Configuration Example of Transmitter and Controlled Object]

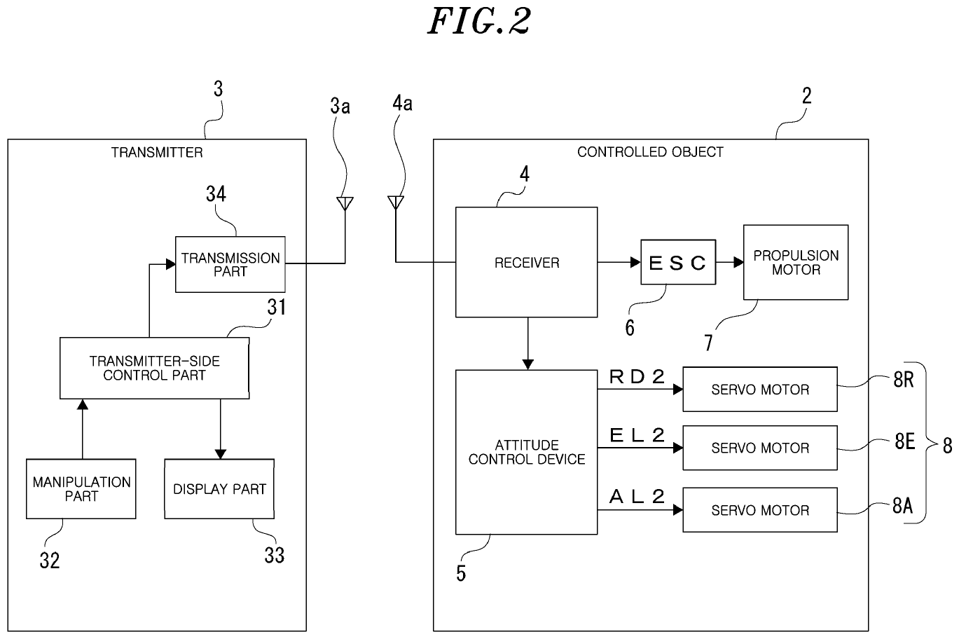

The internal configuration example of the transmitter 3 and the controlled object 2 will be described with reference to the block diagram in FIG. 2.

FIG. 2 shows the electrical configuration example of the transmitter 3 and the controlled object 2, and the mechanical configuration thereof is omitted.

As illustrated in the drawing, the transmitter 3 includes a transmitter-side control part 31, a manipulation part 32, a display part 33, and a transmission part 34.

The manipulation part 32 comprehensively represents a manipulation element for allowing a user to input various manipulation inputs to the transmitter 3. Specifically, it comprehensively represents the above-described stick-shaped manipulation element 3b for control operations, and manipulation elements for various operations other than the control operations, such as buttons, keys, levers, touch panels, and the like.

In the transmitter 3 of the present embodiment, a touch panel for detecting touch operations on the screen is formed on the above-described display screen 33a, and the manipulation element in the manipulation part 32 includes the touch panel.

The display part 33 includes a display device such as a liquid crystal display (LCD) or an organic electro luminescence (EL) display, and displays various information to the user. The above-described display screen 33a is a display screen on the display part 33.

The transmitter-side control part 31 includes a microcomputer provided with, e.g., a central processing unit (CPU), a read only memory (ROM), and a random access memory (RAM). The CPU performs overall control of the transmitter 3 by executing processing corresponding to a program stored in a memory such as the ROM.

For example, the transmitter-side control part 31 performs processing for generating a control signal based on the manipulation of the manipulation element 3b in the manipulation part 32.

Further, the transmitter-side control part 31 performs processing for displaying various information on the display part 33 based on the manipulation on a specific manipulation element other than the manipulation element 3b in the manipulation part 32, particularly on the touch panel on the display screen 33a in the present embodiment. For example, the transmitter-side control part 31 performs processing for causing the display part 33 to display a setting menu screen, or display a setting screen for an item selected on the setting menu screen.

Further, the transmitter-side control part 31 performs processing for causing the transmitter part 34 to transmit the generated control signal and other signals to the controlled object 2.

The transmitter part 34 transmits the signal instructed by the transmitter-side control part 31 via the antenna 3a.

Further, the transmitter part 34 may have a receiving function in addition to a transmitting function. If a receiver 4 to be described later has a transmitting function, the transmitter 3 can receive information acquired by the controlled object 2. For example, when the controlled object 2 is provided with a monitoring sensor such as a temperature sensor or a rotation speed sensor of the propeller 25 (propulsion motor 7 to be described later), the information detected by the sensor can be received on the transmitter 3 side and displayed on the display part 33.

The controlled object 2 includes the receiver 4, an attitude control device 5, an electronic speed controller (ESC) (also referred to as speed controller) 6, the propulsion motor 7, and a plurality of servo motors 8 (8R, 8E, and 8A).

The propulsion motor 7 is a motor that rotates and drives the propeller 25 shown in FIG. 1. For example, a motor that can switch the rotation direction depending on the polarity of the driving current is used as the propulsion motor 7.

There are three servo motors 8, i.e., a servo motor 8A that drives the aileron 26, a servo motor 8E that drives the elevator 27, and a servo motor 8R that drives the rudder 28.

The receiver 4 has an antenna 4a, and receives a signal transmitted by the transmitting part 34 in the transmitter 3. The receiver 4 outputs the received signal to the ESC 6 and the attitude control device 5.

The ESC 6 acquires a control signal that instructs the operation of the propeller 25, which is included in the transmission signal inputted from the transmitter 3 via the receiver 4, and generates based on the control signal a driving signal for the propulsion motor 6.

The driving signal is outputted to the propulsion motor 7, and the propulsion motor 7 is driven.

The attitude control device 5 has sensors (three-axis angular velocity acceleration sensor 11) corresponding to the roll axis, the pitch axis, and the yaw axis, as will be described later, and serves as a unit that controls the attitude of the controlled object 2 based on the detection signals, i.e., signals of angular velocities and accelerations of the respective axes.

As will be described in detail later, the attitude control device 5 extracts the aileron control signal that instructs the operation of the aileron 26, the elevator control signal that instructs the operation of the elevator 27, and the rudder control signal that instructs the operation of the rudder 28, which are included in the transmission signal inputted from the transmitter 3 via the receiver 4, and generates driving signals for achieving attitude control (attitude stabilization control) as driving signals AL2, EL2, and RD2 for the servo motors 8A, 8E, and 8R, respectively, based on thee control signals and the detection signals of the sensors.

In this manner, the attitude control device 5 drives the servo motors 8A, 8E, and 8R based on the driving signals AL2, EL2, and RD2 generated by the attitude control device 5, respectively, thereby achieving the attitude stabilization control of the controlled object 2.

### [1-3 Configuration and Processing of Attitude Control Device]

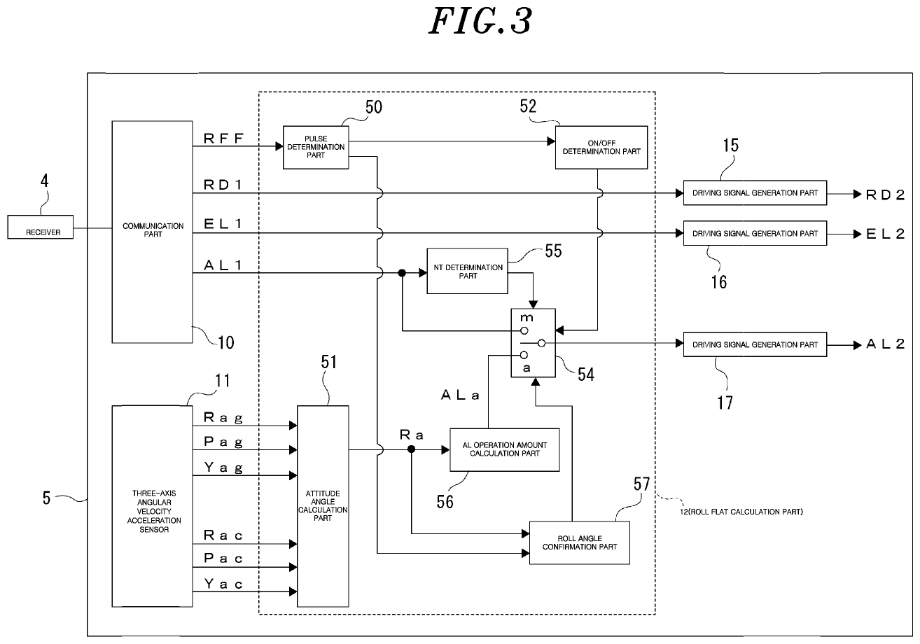

FIG. 3 shows the configuration example of the attitude control device 5. FIG. 3 shows a configuration in which the case of outputting the driving signals AL2, EL2, and RD2 to the servo motors 8A, 8E, and 8R according to the aileron control signal AL1, the elevator control signal EL1, and the rudder control signal RD1 transmitted from the transmitter 3 (i.e., when the flight assist function is not performed) and the case of outputting the driving signals by the roll flat function to the servo motors 8A, 8E, and 8R (i.e., when the flight assist function is activated) can be switched.

FIG. 3 shows the configuration example in which the roll flat function is realized, but the function of automatically returning to level flight is not illustrated. The attitude control device 5 may have both the function of automatically returning to level flight and the roll flat function, and a user can randomly select one to be activated. However, this will be described in the third embodiment, and the roll flat function will be mainly described in the first embodiment.

The attitude control device 5 may be provided with functions or circuit blocks other than those illustrated in the drawing, or some of the functions or circuit blocks that are illustrated may not be provided.

FIG. 3 also shows the receiver 4 shown in FIG. 2 together with the configuration example of the attitude control device 5.

The attitude control device 5 has a communication part 10, a three-axis angular velocity acceleration sensor 11 (hereinafter, referred to as “sensor 11”), a roll flat calculation part 12, and driving signal generation parts 15, 16, and 17.

The communication part 10 receives a signal from the transmitter 3, which is received by the receiver 4. Although detailed description thereof will be omitted, the attitude control device 5 can transmit information to an external device via the communication part 10.

The sensor 11 detects an angular velocity Rag and an acceleration Rac around the roll axis (the direction of rotation by the aileron 26), an angular velocity Pag and an acceleration Pac around the pitch axis (the direction of rotation by the elevator 27), and an angular velocity Yag and an acceleration Yac around the yaw axis (the direction of rotation by the rudder 28).

The roll flat calculation part 12 is configured to perform wired communication with an external device via the communication part 10. During the control of the controlled object 2, the receiver 4 is wired connected to the communication part 10 as illustrated in the drawing, and the roll flat calculation part 12 can receive the transmission signal from the transmitter 3, which is received by the receiver 4, via the communication part 10.

Specifically, the roll flat calculation part 12 receives the rudder control signal RD1, the elevator control signal EL1, the aileron control signal AL1, and the function setting signal RFF as the transmission signals from the transmitter 3.

Further, when the roll flat function is not activated, the roll flat calculation part 12 supplies the rudder control signal RD1, the elevator control signal EL1, and the aileron control signal AL1 to the driving signal generation parts 15, 16, and 17, respectively.

The driving signal generation part 15 generates the driving signal RD2 for the servo motor 8R based on the rudder control signal RD1.

The driving signal generation part 16 generates the driving signal EL2 for the servo motor 8E based on the elevator control signal EL1.

The driving signal generation part 17 generates the driving signal AL2 for the servo motor 8A based on the aileron control signal AL1.

By supplying the driving signals RD2, EL2, and AL2 to the servo motors 8R, 8E, and 8A, the attitude of the controlled object 2 is controlled in response to the operation of the operator using the transmitter 3.

When the roll flat function of the present embodiment is activated, the rudder operation signal RD1 is supplied to the driving signal generator 15, and the elevator operation signal EL1 is supplied to the driving signal generator 16. In other words, the rudder operation and the elevator operation by the operator are directly reflected to the rudder 28 and the elevator 27. The aileron operation signal ALa is supplied to the driving signal generator 17. The aileron operation signal ALa is an operation signal that is automatically generated for returning to a horizontal state based on the detection signal of the sensor 11.

In other words, when the roll flat function is not activated, the aileron operation signal AL1 is selected and supplied to the driving signal generator 17. Since the aileron operation signal ALa is supplied to the driving signal generator 17, the roll flat function is activated.

The functional configuration of the roll flat calculation part 12 for the activation of the roll flat function will be described.

In particular, the roll flat function of the present embodiment is not activated or continued simply by the instruction for turning on the roll flat function. The roll flat function of the present embodiment is activated and continued when the following conditions are satisfied: the instruction for turning on the roll flat function is received from the transmitter 3; the aileron control signal AL1 is a signal indicating neutral; and the roll angle of the controlled object 2 is within a set angle. Here, the state in which the roll flat function is activated and continued refers to a state in which the aileron control signal ALa is supplied to the driving signal generator 17. FIG. 3 shows the configuration of the roll flat calculation part 12, which controls the activation/non-activation of the roll flat function under the above conditions.

The roll flat calculation part 12 can be realized as a calculation device using a microprocessor, or a calculation device using a hardware logic circuit. Further, the roll flat calculation part 12 has a function illustrated in the drawing as a processing function using software or a processing function using a hardware logic circuit. In other words, the roll flat calculation part 12 includes a pulse determination part 50, an attitude angle calculation part 51, an ON/OFF determination part 52, a selection part 54, a neutral determination part 55, an aileron operation amount calculation part 56, and a roll angle confirmation part 57.

The pulse determination part 50 receives the function setting signal RFF from the transmitter 3 via the communication part 10, and determines the pulse width of the ON side of the function setting signal RFF. The transmitter 3 transmits the user's ON/OFF operation of the roll flat function and information on the preset roll angle by the function setting signal RFF. In this case, the roll angle information is the information on the set angle, which is one of the conditions for activating the roll flat function.

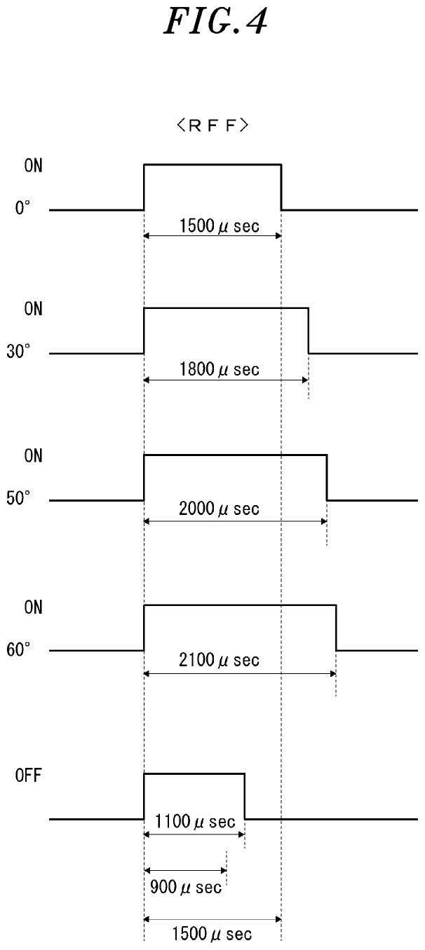

FIG. 4 shows the function setting signal RFF. The function setting signal RFF is a signal that generates H level pulses of 1500 μsec±600 μsec at a period of 15 msec, for example.

In the drawing, the H level periods of 1500 μsec, 1800 μsec, 2000 μsec, 2100 μsec, and 1100 μsec are illustrated. The pulse widths are determined by the user's setting operation on the transmitter 3 side.

The pulse widths serve as the information indicating the instruction for turning on/off the function, and the set angle for the roll angle, i.e., the roll angle as the function activation condition.

For example, when the function setting signal RFF is a signal with an H level period of 1500 μsec±600 μsec, it indicates that the roll flat function is ON in the H level period from 1500 μsec to 2100 μsec.

In the H level period from 1499 μsec to 900 μsec, it indicates that the roll flat function is OFF. For example, it serves as a signal for instructing turning off of the roll flat function in the H level period of 1100 μsec as shown in the drawing.

The pulse width (duration) of the H level pulse from 1500 μsec to 2100 μsec, which indicates that the roll flat function is ON, indicates the roll angle. For example, 1500 μsec is 0°, and the angle increases at a rate of 1° every 10 μsec. Therefore, as illustrated in the drawing, the roll angle is 30° at 1800 μsec, 50° at 2000 μsec, and 60° at 2100 μsec.

For example, in this example, the user can set any angle between 0° and 60° as the condition for activating the roll flat function.

At the set angle of 0°, the roll flat function is activated only when the roll angle is within 0° or within 180° in the case of backward flight, i.e., when the aircraft is level in forward flight or backward flight.

At the set angle of 30°, the roll flat function is activated when the roll angle is within 0°±30° or 180°±30° in the case of backward flight, i.e., within ±30° from the horizontal state in forward flight or backward flight.

The pulse determination part 50 determines the pulse width of the H level in the function setting signal RFF as described above, and notifies the ON/OFF determination part 52 and the roll angle confirmation part 57 of the pulse width.

If the notified pulse width is 1500 μsec or more, the ON/OFF determination part 52 determines that turning on of the roll flat function is instructed. Then, the ON/OFF determination part 52 notifies the selection part 54 of the ON/OFF determination result of the roll flat function.

The roll angle confirmation part 57 determines the set angle as the condition for the roll angle depending on the pulse width notified by the pulse determination part 50 between 1500 μsec and 2100 μsec. For example, when the pulse width is 1800 μsec, the set angle is ±30°.

The aileron control signal AL1 inputted via the communication part 10 is supplied to the neutral determination part 55 and the selection part 54 (terminal m in the drawing).

The neutral determination part 55 determines whether or not the aileron control signal AL1 is neutral.

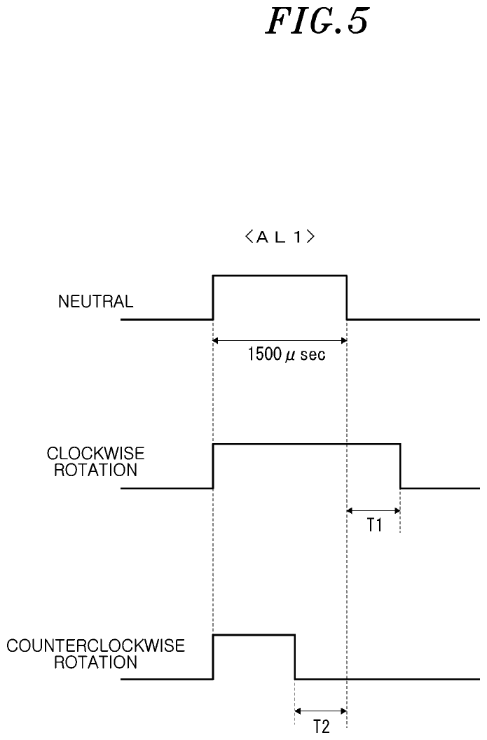

FIG. 5 shows an example of the aileron control signal AL1. For example, the aileron control signal AL1 is a signal that generates an H level pulse at a cycle of 15 msec, similarly to the function setting signal RFF. The aileron control signal AL1 is the information indicating neutral when the H level pulse is 1500 μsec, indicating the clockwise rotation of the servo motor 8 when the H level pulse exceeds 1500 μsec, and indicating the counterclockwise rotation of the servo motor 8 when the H level pulse is less than 1500 μsec.

FIG. 5 shows the cases where the H level periods are 1500 μsec, 1500+T1 μsec, and 1500−T2 μsec.

When the H level period is 1500 μsec, the signal indicates neutral. When the H level period is 1500+T1 μsec, the signal indicates the rightward rotation corresponding to the duration of the period T1.

When the H level period is 1500−T2 μsec, the signal indicates the leftward rotation corresponding to the duration of the period T2.

In this example, the neutral determination part 55 notifies the selection part 54 of the information on whether or not the H level period is 1500 μsec, i.e., whether or not the signal indicates neutral or whether or not the aileron driving is instructed.

The attitude angle calculation part 51 calculates the attitude angle of the controlled object 2 based on the detection signal of the sensor 11. For example, the roll angle Ra, the pitch angle Pa, and the yaw angle Ya are calculated.

The information on the roll angle Ra obtained by the attitude angle calculation part 51 is supplied to the aileron control amount calculation part 56 and the roll angle confirmation part 57.

The roll angle confirmation part 57 compares the roll angle specified by the function setting signal RFF with the current roll angle Ra to determine whether or not the current roll angle Ra is within the set roll angle, and then notifies the selection part 54 of the determination result.

The aileron control amount calculation part 56 calculates the aileron control signal ALa for returning the aircraft attitude of the controlled object 2 to a horizontal state, i.e., for returning the roll angle to 0° (or 180°), based on the current roll angle Ra. The aileron control signal ALa is supplied to the selection part 54 (terminal a in the drawing).

The selection part 54 is illustrated as a switch having terminals m and a, but this is schematic. Although the selection part 54 may be formed as an actual selection circuit, it only requires to select and output any one of the aileron control signal AL1 and the aileron control signal ALa by calculation.

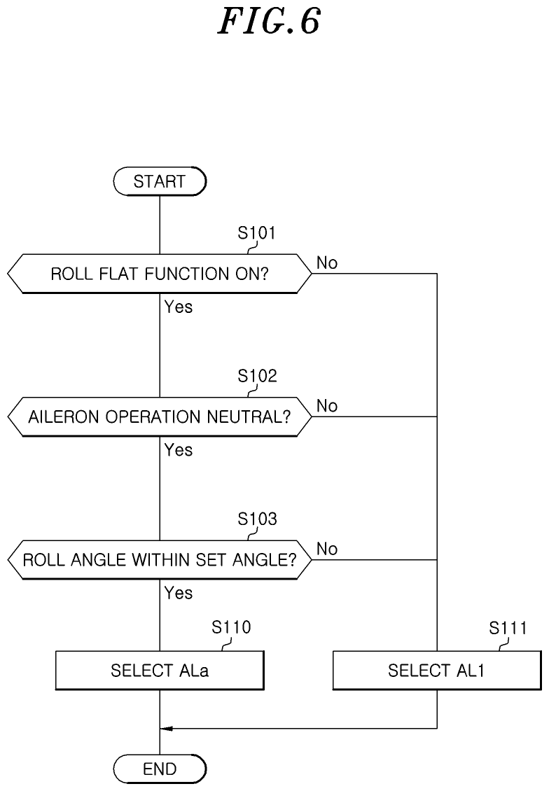

The selection part 54 performs selection processing as shown in FIG. 6, for example.

In step S101, the selection part 54 determines whether or not turning on of the roll flat function is instructed. In other words, it is determined based on the notification from the ON/OFF determination part 52.

In step S102, the selection part 54 determines whether or not the aileron control signal AL1 is neutral based on the notification from the neutral determination part 55.

In step S103, the selection part 54 determines whether or not the current roll angle Ra is within the set roll angle based on the notification from the roll angle confirmation part 57.

If positive results are obtained in all of steps S101, S102, and S103, the selection part 54 proceeds to step S110 to select the terminal a, i.e., the aileron control signal ALa and supply it to the driving signal generation part 17.

If negative results are obtained in any one of steps S101, S102, and S103, the selection part 54 proceeds to step S111 to select the terminal m, i.e., the aileron control signal AL1, and supply it to the driving signal generation part 17.

Due to the above-described function of the roll flat calculation part 12, the aileron control signal ALa is supplied to the driving signal generation part 17 to activate the roll flat function for flight assist when the following conditions are satisfied: turning on of the roll flat function is instructed by the function setting signal RFF from the transmitter 3; the aileron control signal AL1 is a signal indicating neutral; and the roll angle Ra of the controlled object 2 is within a set angle.

In this case, the rudder control signal RD1 and the elevator control signal EL1 are supplied to the driving signal generating parts 15 and 16, so that the user's rudder operation and elevator operation remain valid and unrestricted even during the activation of the roll flat function.

After the roll flat function is activated, the control for automatically maintaining a horizontal state using the aileron control signal ALa is continued until the conditions are no longer satisfied, for example, until the aileron control signal AL1 is in a state other than neutral.

However, when a user operates the aileron, the aileron control signal AL1 is in a state other than neutral. Therefore, the aileron control signal AL1 is selected by the selection part 54, and the roll flat function is released.

From above, the following advantages are obtained.

In the case of the function of automatically returning to level flight described above, if a turn is attempted during the automatic control, the input of the aileron is restricted and the aircraft cannot rotate at a desired angle, resulting in a large turning circle. Further, at the time of landing, it is necessary to input the elevator to raise the nose, but the elevator is automatically operated to return the aircraft to a horizontal attitude, which causes the nose to drop.

In contrast, due to the roll flat function of the present embodiment, even if a turn for landing approach is performed during the activation of the roll flat function, both the aileron operation and the elevator operation can be performed normally. In addition, the aircraft can turn in response to the operation, so that there is no sense of discomfort and operational errors are unlikely to occur.

Further, in a landing position (in a state where the roll angle is level on the extension of the runway), the roll angle is automatically maintained to be level, so that the operator can concentrate on controlling the aircraft speed and altitude, i.e., the operation of the throttle and the elevator.

Further, the elevator remains in normal operation, and thus can be operated without any sense of discomfort.

In addition, the roll flat function enables stable level flight in the air above the front side or the rear side of the aircraft.

Since the roll angle of the aircraft at which the roll flat function is activated can be set from the transmitter 3, beginners can increase the roll angle for activating the roll flat function. Hence, the function can be activated quickly, and the aircraft can be automatically maintained in a horizontal state. On the other hand, advanced operators can activate the roll flat function after the aircraft has reached a substantially horizontal position. In other words, the roll flat function can be used according to the operator's skill and preferences.

### 2. Second Embodiment

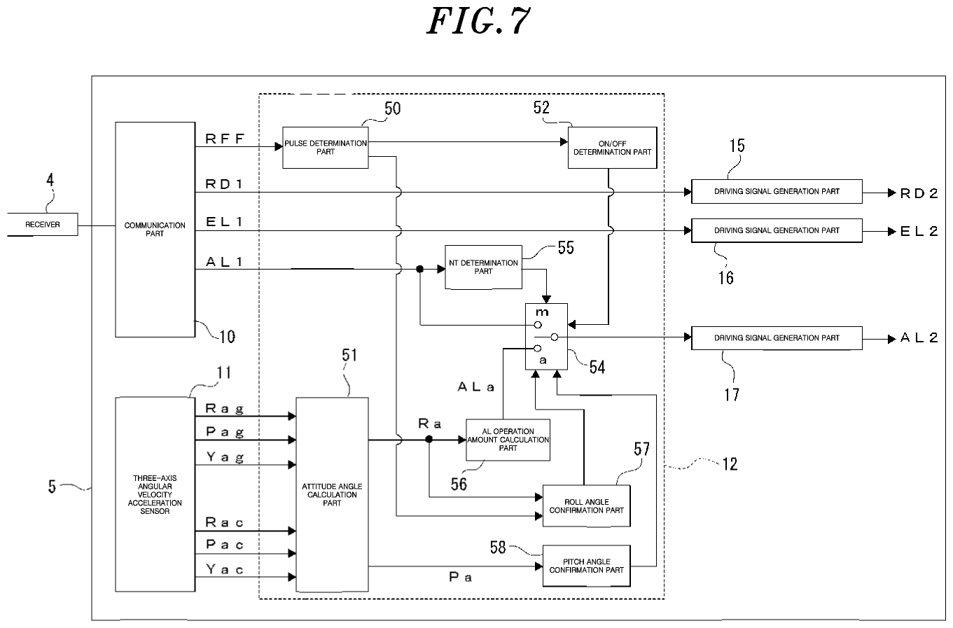

FIG. 7 shows the configuration example of the attitude control device 5 according to a second embodiment. Like reference numerals are used for like parts shown in FIG. 3, and redundant description thereof is omitted. The second embodiment is different from the first embodiment in that a pitch angle confirmation part 58 is provided as shown in FIG. 7.

The pitch angle confirmation part 58 acquires the current pitch angle Pa of the aircraft calculated by the attitude angle calculation part 51, and determines whether or not it is less than or equal to a preset angle. For example, the pitch angle of 60° is preset as the set angle.

In this case, the set angle (for example, 60°) for the pitch angle is set to an angle corresponding to diving flight or soaring flight. In the case of diving flight or soaring flight, it is difficult to determine whether or not the aircraft is horizontal to the ground, and the horizontal state may not be essential. In particular, the roll flat function is meaningless. Therefore, when the pitch angle Pa exceeds the set angle, the roll flat function is released.

Therefore, the pitch angle confirmation part 58 notifies the selection part 54 of the information that has determined whether or not the pitch angle Pa is less than or equal to the set angle.

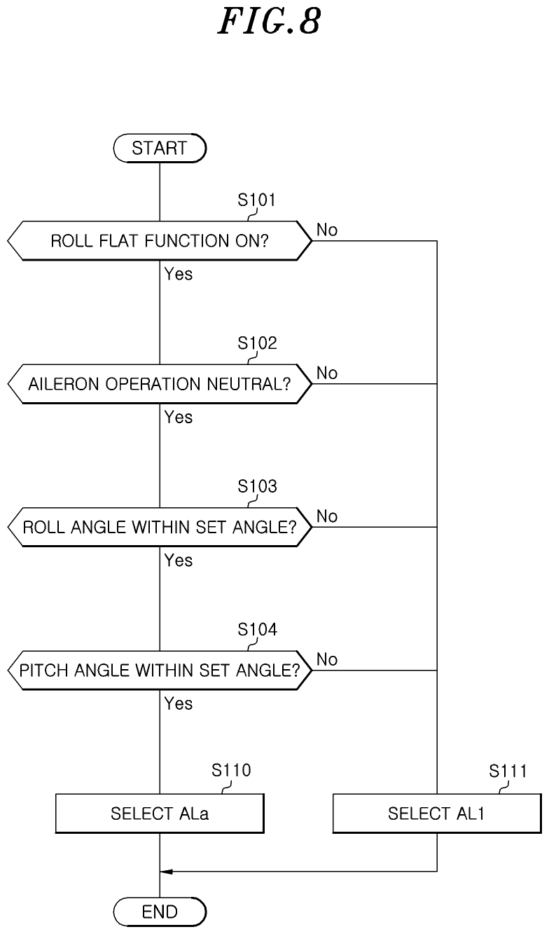

The selection part 54 performs the selection processing as shown in FIG. 8. The same step numbers are used for the same steps shown in FIG. 6 to avoid detailed description thereof.

In steps S101, S102, and S103, the selection part 54 determines whether or not turning on of the roll flat function ON is instructed, whether or not the aileron control signal AL1 is neutral, and whether or not the current roll angle Ra is within the set roll angle.

In step S104, the selection part 54 determines whether or not the current pitch angle Pa is within the set pitch angle based on the notification from the pitch angle confirmation part 58.

If positive results are obtained in all of steps S101, S102, S103, and S104, the selection part 54 proceeds to step S110, selects the aileron control signal ALa, and supplies it to the driving signal generation part 17.

If negative results are obtained in any one of steps S101, S102, S103, and S104, the selection part 54 proceeds to step S111, selects the aileron control signal AL1, and supplies it to the driving signal generation part 17. In the second embodiment, similarly to the first embodiment, the user's manipulation is valid even in a state where the roll flat function is activated, so that the roll flat function is released during diving flight or soaring flight.

Further, the set angle for the pitch angle may be changed by the user's manipulation from the transmitter 3.

### 3. Third Embodiment

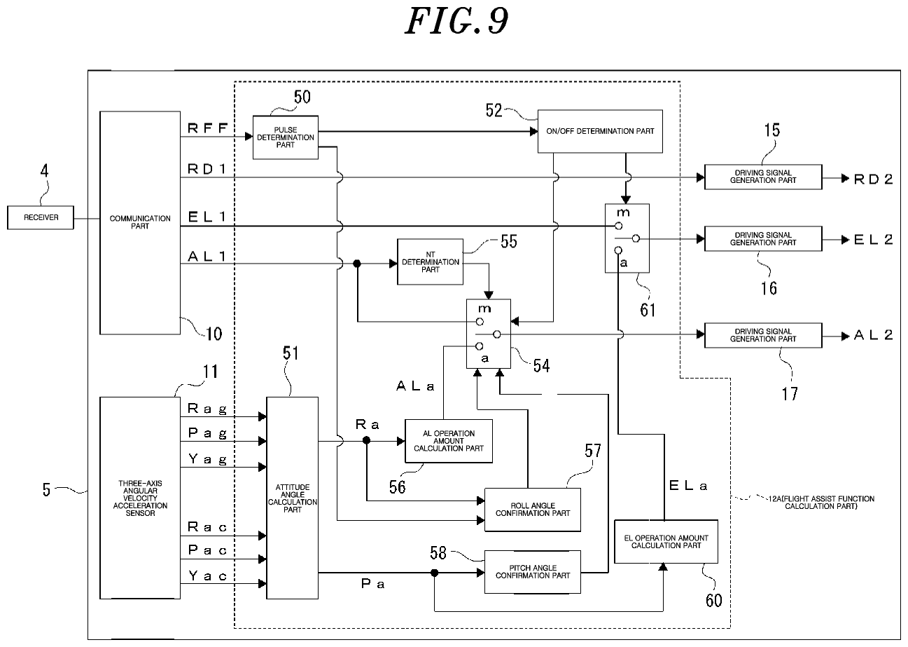

FIG. 9 shows the configuration example of the attitude control device 5 according to a third embodiment. Like reference numerals are used for like parts shown in FIG. 7, and redundant description thereof will be omitted.

FIG. 9 shows an example in which the roll flat function and the automatic return to level flight function coexist, and the function is selected by the function setting signal RFF of one signal transmission channel from the transmitter 3. Therefore, the part corresponding to the roll flat calculation part 12 in FIG. 7 is shown as a flight assist function calculation part 12A.

The function of automatically returning to level flight, is a function of outputting the aileron control signal ALa calculated to maintain the controlled object 2 in a horizontal state based on the roll angle Ra of the controlled object 2, and the elevator control signal ELa calculated to maintain the controlled object 2 in a horizontal state based on the pitch angle Pa of the controlled object 2 when the condition that the function is turned on is satisfied. Therefore, in FIG. 9, the elevator operation amount calculation part 60 and the selection part 61 are provided in addition to the configuration of FIG. 7.

The elevator operation amount calculation part 60 calculates the elevator operation amount for returning to a horizontal state based on the current pitch angle Pa calculated by the attitude angle calculation part 51, and outputs the elevator operation signal ELa. The elevator operation signal ELa is supplied to the selection part 61 (terminal a in the drawing).

The selection part 61 is illustrated as a switch having terminals m and a, but this is schematic. Although the selection part 61 may be formed as an actual selection circuit, it only requires to select and output any one of the elevator operation signal EL1 and the elevator operation signal ELa by calculation.

The ON/OFF determination part 52 determines whether or not the function is OFF, the roll flat function is ON, or the function of automatically returning to level flight is ON based on the pulse width of the function setting signal RFF. Then, the ON/OFF determination part 52 notifies the selection parts 54 and 61 of the determination result.

For example, as described in FIG. 4, when the H level pulse width is 1500 μsec or more, it is determined that the roll flat function is ON, and the set angle as the condition of the roll angle condition is determined. In this case, the roll flat function is ON when the H level period is between 1500 μsec and less than 2100 μsec, and the duration of the H level period indicates the roll angle.

Further, when the duration of the H level period is 2100 μsec, which is maximum, it is determined that the function of automatically returning to level flight is ON.

In other words, the pulse width is used to determine whether or not the roll flat function is ON or whether or not the function of automatically returning to level flight is ON.

The following is description of the selection processing performed by the selection parts 54 and 61.

If the pulse width of the function setting signal RFF is less than 1500 μsec and the flight assist function is OFF, both the selection parts 54 and 61 select the terminal m. Therefore, the aileron control signal AL1 and the elevator control signal EL1 are supplied to the driving signal generation parts 16 and 17.

If the pulse width of the function setting signal RFF is between 1500 μsec and less than 2100 μsec, the selection part 54 determines that turning on of the roll flat function is instructed, and selects the aileron control signal AL1 or the aileron control signal ALa in the processing example of FIG. 8. On the other hand, the selection part 61 constantly selects the elevator control signal EL1 (terminal m). In other words, the selection is made by the roll flat function described above.

If the pulse width of the function setting signal RFF is 2100 μsec, both of the selection parts 54 and 61 select the terminal a. Therefore, the aileron control signal ALa and the elevator control signal ELa are supplied to the driving signal generation parts 16 and 17. Accordingly, the function of automatically returning to level flight is activated.

In both cases of the roll flat function and the function of automatically returning to level flight, the rudder control signal RD1 is supplied to the driving signal generation part 15.

In actual cases, even if the function of automatically returning to level flight is ON, the aileron operation and the elevator operation are restricted, but are not disabled. Therefore, the aileron operation amount calculation part 56 shown in FIG. 9 calculates the aileron operation signal ALa while referring to the aileron operation signal AL1 in addition to the roll angle Ra. Further, the elevator operation amount calculation part 60 calculates the elevator operation signal ELa while referring to the elevator operation signal EL1 in addition to the pitch angle Pa.

In accordance with the configuration shown in FIG. 9, both the roll flat function and the function of automatically returning to level flight can be selectively activated. Further, the roll flat function and the function of automatically returning to level flight can be controlled by one signal transmission channel from the transmitter 3.

In addition, independent signal transmission channels may be used for controlling the roll flat function and the function of automatically returning to level flight. In that case, if turning on of the function is instructed in both channels, the attitude control device 5 can prioritize one of the functions and interpret the instruction as the ON instruction of the prioritized function.

In the third embodiment, the roll flat function was described as the activation condition including the pitch angle condition described in the second embodiment. However, it is possible to determine whether or not the roll flat function is activated based on the conditions of FIG. 6 described in the first embodiment.

### 4. Effects of Embodiments

In accordance with the above embodiments, the following effects can be obtained.

The attitude control device 5 of the first embodiment includes the roll flat calculation part 12 that selectively outputs the first aileron control signal AL1 inputted as the control signal and the second aileron control signal ALa calculated based on the roll angle Ra of the controlled object 2 to maintain the controlled object 2 in a horizontal state. Further, the roll flat calculation part 12 is configured to selectively output the second aileron control signal ALa when the following conditions are satisfied: turning on of the roll flat function is instructed by the function setting signal RFF; the first aileron control signal AL1 is a signal indicating neutral; and the roll angle Ra of the controlled object 2 is within a set angle.

Due to the roll flat function, the automatic aileron control is performed only when turning on of the roll flat function is instructed, there is no aileron operation by a user, and the roll angle of the aircraft of the controlled object 2 is within a predetermined angle from the horizontal state. The automatic aileron control is performed when the automatic level control using the roll flat function does not affect the user's control, which makes it possible to improve controllability and realize the control according to the operator's skill.

In the attitude control device 5 of the second embodiment, the roll flat calculation part 12 is configured to select and output the second aileron control signal ALa when the following conditions are satisfied: turning on of the roll flat function is instructed by the function setting signal RFF; the first aileron control signal AL1 is a signal indicating neutral; the roll angle Ra of the controlled object 2 is within a set angle; and the pitch angle Pa of the controlled object 2 is within a set angle.

In other words, the condition that the pitch angle Pa is within a set angle is added as the condition for activating the roll flat function.

By considering the pitch angle, it is possible to prevent the roll flat function from being activated when the roll flat function is meaningless, for example, during diving flight or soaring flight. In other words, the roll flat function is activated when the level control is effective.

In the first, second, and third embodiments, the roll flat calculation part 12 is configured to select and outputs the first aileron control signal AL1 except when the conditions are satisfied

Therefore, even when the aileron control signal ALa is outputted from the selection part 54 due to the roll flat function, if the aileron control signal AL1 by the control signal is not neutral, the aileron control signal AL1 is outputted immediately from the selection part 54. In other words, if the aileron operation is performed during the activation of the roll flat function, the aileron operation is accepted. Accordingly, it is possible to perform a turning operation without any discomfort, and the operational errors are unlikely to occur.

In the first, second and third embodiments, during the period in which the second aileron control signal ALa is selected and outputted due to the conditions being satisfied, the roll flat calculation part 12 is configured to output, for the elevator control, the elevator control signal EL1 inputted as the control signal from the transmitter 3.

Even if the roll flat function is controlled, the elevator operate normally and, thus, the operation can be performed without any discomfort. Particularly during landing, the roll angle can be automatically controlled, so that the operator can concentrate on operating the elevator and the throttle.

In the first, second and third embodiments, the roll flat calculation part 12 is configured to set the set angle as the condition for the roll angle of the controlled object 2 based on the pulse width of the function setting signal RFF.

Hence, the angle range for automatic control of the roll angle can be set from the transmitter 3 side, so that the angle range for automatic control can be changed depending on the operator's skill. A beginner can perform automatic level control when the roll angle deviates from the horizontal state to a certain extent, and an advanced operator can perform automatic level control only in a substantially horizontal attitude.

Further, by specifying the set angle as the condition for the roll angle using the pulse width, the ON/OFF control of the roll flat function and the angle setting can be performed using one channel from the transmitter 3, and the transmission information can be efficiently used. Further, 1500 μsec to 2100 μsec described above is an example for description purposes. There is no particular limitation on the specific numerical value of the pulse width.

In the third embodiment, the roll flat calculation part 12 is configured to output the aileron control signal ALa and the elevator control signal ELa when the pulse width of the function setting signal RFF is a predetermined value, e.g., the maximum value. In other words, the function of automatically returning to level flight is turned on.

Accordingly, the roll flat function and the control of automatically returning to level flight can be controlled by the function setting signal RFF of one channel, and the information transmitted from the transmitter 3 can be efficiently used. Although an example in which the pulse width is the maximum value (for example, 2100 μsec) has been described, the maximum value of 2100 μsec is an example. Further, although the maximum value has been described as an example, the pulse width may not be the maximum value, and a certain pulse width may specify turning on of the function of automatically returning to level flight.

1. An attitude control device mounted on a radio-controlled model airplane, which is a controlled object controlled based on a control signal received from an external device, comprising:
a calculation part configured to selectively output a first aileron control signal, which is input as the control signal, and a second aileron control signal, which is calculated based on a roll angle of the controlled object to maintain the controlled object in a horizontal state,
wherein the calculation part selects and outputs the second aileron control signal when the following conditions are satisfied: turning on of a function is instructed by a function setting signal received from the external device; the first aileron control signal is a signal indicating neutral; and the roll angle of the controlled object is within a set angle.

2. An attitude control device mounted on a radio-controlled model airplane, which is a controlled object controlled based on a control signal received from an external device, comprising:
a calculation part configured to selectively output a first aileron control signal, which is input as the control signal, and a second aileron control signal, which is calculated based on the roll angle of the controlled object to maintain the controlled object in a horizontal state,
wherein the calculation part selects and outputs the second aileron control signal when the following conditions are satisfied: turning on of a function is instructed by a function setting signal received from the external device; the first aileron control signal is a signal indicating neutral; the roll angle of the controlled object is within a set angle; and a pitch angle of the controlled object is within a set angle.

3. The attitude control device of claim 1, wherein the calculation part selects and outputs the first aileron control signal except when the conditions are satisfied.

4. The attitude control device of claim 2, wherein the calculation part selects and outputs the first aileron control signal except when the conditions are satisfied.

5. The attitude control device of claim 1, wherein the calculation part outputs, for elevator control, an elevator control signal which is input as the control signal during a period in which the second aileron control signal is selected and outputted due to satisfaction of the conditions.

6. The attitude control device of claim 2, wherein the calculation part outputs, for elevator control, an elevator control signal which is input as the control signal during a period in which the second aileron control signal is selected and outputted due to satisfaction of the conditions.

7. The attitude control device of claim 1, wherein the calculation part sets a set angle as a condition for the roll angle of the controlled object based on a pulse width of the function setting signal.

8. The attitude control device of claim 2, wherein the calculation part sets a set angle as a condition for the roll angle of the controlled object based on a pulse width of the function setting signal.

9. The attitude control device of claim 7, wherein, when the pulse width of the function setting signal is a predetermined value, the calculation part outputs an aileron control signal calculated based on the roll angle of the controlled object to maintain the controlled object in a horizontal state, and an elevator control signal calculated based on a pitch angle of the controlled object to maintain the controlled object in a horizontal state.

10. The attitude control device of claim 8, wherein, when the pulse width of the function setting signal is a predetermined value, the calculation part outputs an aileron control signal calculated based on the roll angle of the controlled object to maintain the controlled object in a horizontal state, and an elevator control signal calculated based on the pitch angle of the controlled object to maintain the controlled object in a horizontal state.
